(19) United States
(12) Patent Application Publication
(10) Pub. No.: US 2012/0017771 A1
(43) Pub. Date: Jan. 26, 2012

(54) INTERNALLY ELECTRIC HEATED BARBECUE

(76) Inventor: Lin Li, Shanghai (CN)

(21) Appl. No.: 12/841,842

(22) Filed: Jul. 22, 2010

(51) Int. Cl. A47J 37/06; A47J 37/08

(52) U.S. Cl. 99/332; 99/389

(57) ABSTRACT

An internally electric heated barbecue comprising a cabinet with at least one upper opening is provided in the present invention. The cabinet has electric heating units on both sides inside it; the opening has rack supporting part to support the barbecue rack, and the opening is 55 mm-100 mm wide; the barbecue rack consists of a barbecue frame and a support rod holder, the barbecue frame is within the opening, and the support rod holder is on the supporting part; the barbecue rack is equipped with food skewers, and the food skewer comprises a handle, a support locating part and a food fixing part. The internally electric heated barbecue provided in the present invention is characterized in that the operation is simple, safe and cleanness, and that it can effectively reduce the energy consumption and control the barbecue quality.

### BACKGROUND OF THE INVENTION

1. Technical Field

The invention relates to a barbecue, in particular to an internally electric heated barbecue.

2. Description of Related Art

The barbecue devices in the current market are mainly direct fired barbecues that burn charcoal as the origin of heat, which apply a top-opening cabinet structure. The ignited charcoal is placed at the bottom of the cabinet while using, and generally the barbecuing area is above the heating area, e.g. a net rack is on the upper part of the cabinet for the food to be barbecued. The potential problem is that the ignition of charcoal is quite difficult. And the burning of charcoal will bring a large amount of smoke and ash, which not only causes the pollution of the air but also affects the cleanness of the barbecued food. And it is easy to cause the food undercooked or scorched due to the difficulty of control of the fire temperature, thus being difficult to control the quality of food. In order to solve the problems of the charcoal burned barbecue, some top-opening electrically heated barbecues are designed. However, since the issues regarding temperature adjustment and time adjustment of the barbecue are not solved, the quality of the barbecued food remains unsatisfied. Additionally, since the temperature at the lower part is much higher than in the upper part of such barbecue, the heat may lose during the process of heat transfer from the bottom up which causes the waste of energy, and the food may fall down to the bottom of the device during barbecuing thus being burnt and causing smog pollution which makes the barbecue difficult to clean after cooking. Since the current barbecuing device can only heat one side of the food, the user is required to flip the food constantly during barbecuing to evenly heat both sides of the food, and the barbecuing condition of the food needs to be judged by experience, which makes it difficult to control the food quality.

### SUMMARY OF THE INVENTION

An internally electric heated barbecue is provided in the present invention, which created a brand-new way to simplify the operation of barbecue and make it safe and clean, through which the food quality can be controlled effectively.

In order to achieve the above-mentioned purposes, the present invention provides an internally electric heated barbecue, which comprises a cabinet and a barbecue rack; the cabinet has a rack supporting part and at least one opening at its top, each opening having a width of 55 mm-100 mm; the cabinet further comprises electric heating units, which are disposed at both sides inside the cabinet; the barbecue rack comprises a barbecue frame and a support rod holder, the barbecue frame being disposed within the opening, the support rod holder being supported by the rack supporting part; the barbecue rack is further equipped with food skewers.

Further, the electric heating unit has an asymmetrical structure to provide more heat to the bottom of the cabinet. In one embodiment of the present invention, the electric heating unit comprises a plurality of parallel arranged heating tubes, and the intervals between adjacent heating tubes decrease from top down.

Further, the rack supporting part has a concavity and a supporting part, the barbecue rack's support rod holder has a convexity matching with the concavity to limit the position of the barbecue rack, and the rack supporting part is used to support the barbecue rack's support rod holder.

Further, the barbecue rack's barbecue frame includes a first frame and a second frame, which are pin joined at one end of them; the barbecue rack's support rod holder includes a first rod holder and a second rod holder, which are fixed separately and connected to the other sides of the two frames.

Further, blocking racks are mounted on the two frames near the pin joining part to avoid food from falling to the bottom of the cabinet when barbecuing, and the two frames have arc withstanding frames respectively mounted at the outer sides.

Further, the first frame and the second frame are pin joined by rotating shafts, wherein, the rotating shafts can limit the open angle of the frames.

Further, the two rod holders have buckling parts matching with each other.

Further, the food skewer comprises a handle, a support locating part and a food fixing part, wherein the food fixing part is cylindrical or flat, and the food fixing part contains a plurality of limiting embosses.

Further, the support locating part is a locating disc, the food fixing part is clamped by the barbecue rack, and the support locating part limits the handle to outside of the barbecue rack.

Further, the cabinet has a removable water tank at the bottom.

Further, the internally electric heated barbecue has a temperature control unit and a timing unit.

The internally electric heated barbecue presented in the invention has an opening with appropriate width, which avoids the food sanitation problems caused by the contact of the food with other parts of the cabinet due to small opening during placing the barbecue rack into the barbecue and the burnt smell problem during barbecuing, and also avoids the energy-consuming problem caused by rapid heat loss and the uneven food heating problem due to big opening, thus reducing the power consumption. The combination of two-sided vertical heating unit with asymmetrical structure and the barbecue rack provides relatively even and stable temperature inside the barbecue, having no need of flipping food, instead, makes barbecuing easy and controllable by controlling the time and temperature. Therefore users are free from the complicated process and it becomes a good assistant in the daily cooking in the kitchen. The present invention has the advantages of having no smog, being easy to clean and convenient to operate, consuming much less power than traditional barbecues, capable of removing excessive grease effectively and controlling barbecuing quality accurately.

### BRIEF DESCRIPTION OF THE DRAWINGS

FIG. 1 is a schematic representation of the preferred embodiment of the internally electric heated barbecue's structure in the present invention.

FIG. 2 is a schematic representation of the preferred embodiment of the internally electric heated barbecue's top opening in the present invention.

FIG. 3 is a schematic representation of the preferred embodiment of the internally electric heated barbecue's structure decomposition in the present invention.

FIG. 4 is a schematic representation of the preferred embodiment of the electric heating unit in the present invention.

FIG. 5 to FIG. 7 are schematic representations of another preferred embodiment of the internally electric heated barbecue's structure in the present invention.

FIG. 8 is a schematic representation of the preferred embodiment of the barbecue rack's closing status in the present invention.

FIG. 9 is a schematic representation of the preferred embodiment of the barbecue rack's opening status in the present invention.

FIG. 10 is a schematic representation of the preferred embodiment of the barbecue rack's utilizing status in the present invention.

FIG. 11a and FIG. 11b are schematic representations of the barbecue frames respectively in a closing and an opening status.

FIG. 12a, FIG. 12b and FIG. 12c are schematic representations of the preferred embodiment of the food skewer's structure.

FIG. 13 is a schematic representation of the preferred embodiment of the internally electric heated barbecue's overall structure in the present invention.

### DETAILED DESCRIPTION OF THE INVENTION

For a better description of the technical contents of the present invention, the specific preferred embodiments are hereby given as follows with reference to the appended drawings.

An internally electric heated barbecue provided in the present invention is characterized in a simple, safe and clean operation, and it has an effective way to control the food quality.

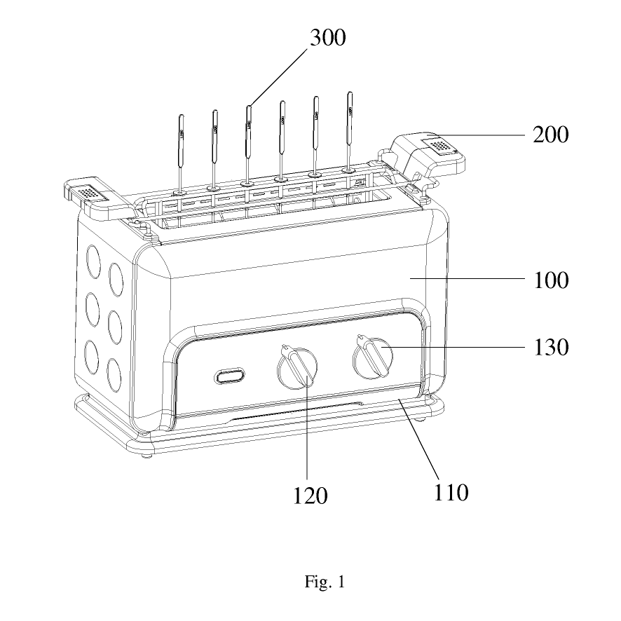

Refer to FIG. 1. FIG. 1 is a schematic representation of the preferred embodiment of the internally electric heated barbecue's structure in the present invention. As shown in the figure, the internally electric heated barbecue provided in the present invention comprises a cabinet 100 with an upper opening, a barbecue rack 200 equipped with food skewers 300 located inside the cabinet 100 and at the opening, wherein the barbecue cabinet 100 has a removable water tank 110 at the bottom; the removable water tank 110 is used to collect liquids like the water or oil drops from the food while barbecuing, and such removable water tank 110 can be easily taken out from the cabinet 100 for cleaning and be installed again to ensure the internal cleanness of the cabinet of the barbecue. The barbecue has timing unit 120 and temperature control unit 130 (accurate electronic temperature control or electronic timing also acceptable) at the side to control the barbecue temperature inside the barbecue and time the barbecuing, so as to accurately control the barbecuing quality.

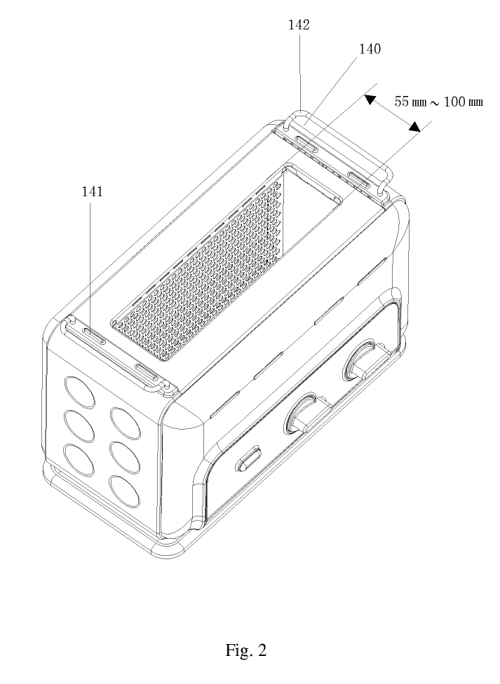

Refer to FIG. 2. FIG. 2 is a schematic representation of the preferred embodiment of the internally electric heated barbecue's top opening in the present invention. As shown in the figure, the internally electric heated barbecue in the present invention has a top opening with a width of 55 mm-100 mm; when the opening is too small, the food is likely to touch other parts of the barbecue cabinet 100 while placing the barbecue rack 200 into the barbecue cabinet 100, which is unclean and tend to release burnt smell during barbecuing. But if the opening is too large, the heat loss inside the barbecue will be rapid, which will not only increase the energy consumption, but also lead to uneven heating of the food. The present invention sets the width of the top opening on the cabinet 100 to be 55 mm-100 mm for the best result; the cabinet 100 of the internally electric heated barbecue provided in the present invention may have more than one top opening so as to barbecue lots of food, wherein the number of the top openings can be tailored in accordance with the customer requirement, and each opening has the width of 55 mm-100 mm. Also as shown in FIG. 2, the cabinet 100 has rack supporting part 140 on the top of it for supporting the barbecue rack 200, and the rack supporting part 140 has a concavity 141 and a supporting part 142, wherein the concavity 141 is used to limit the position of the barbecue rack 200 on the top opening of the cabinet 100, while the supporting part 142 is used to support the barbecue rack 200 to prevent it from falling into the cabinet 100.

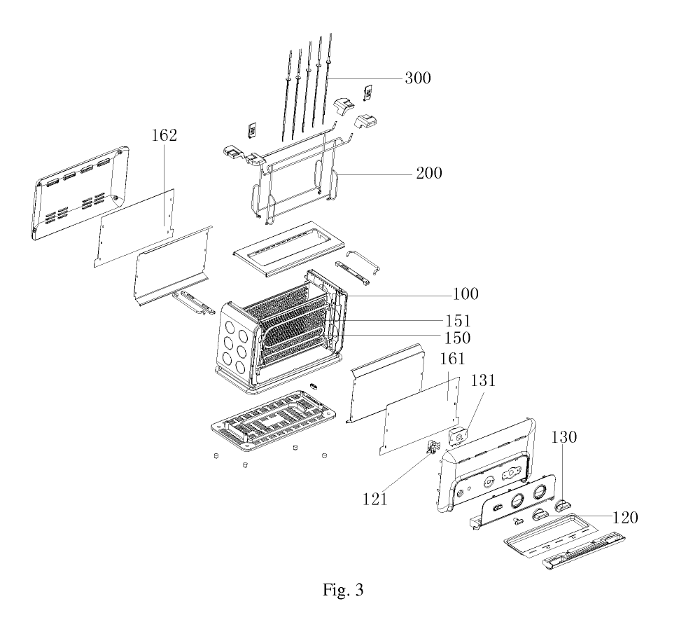

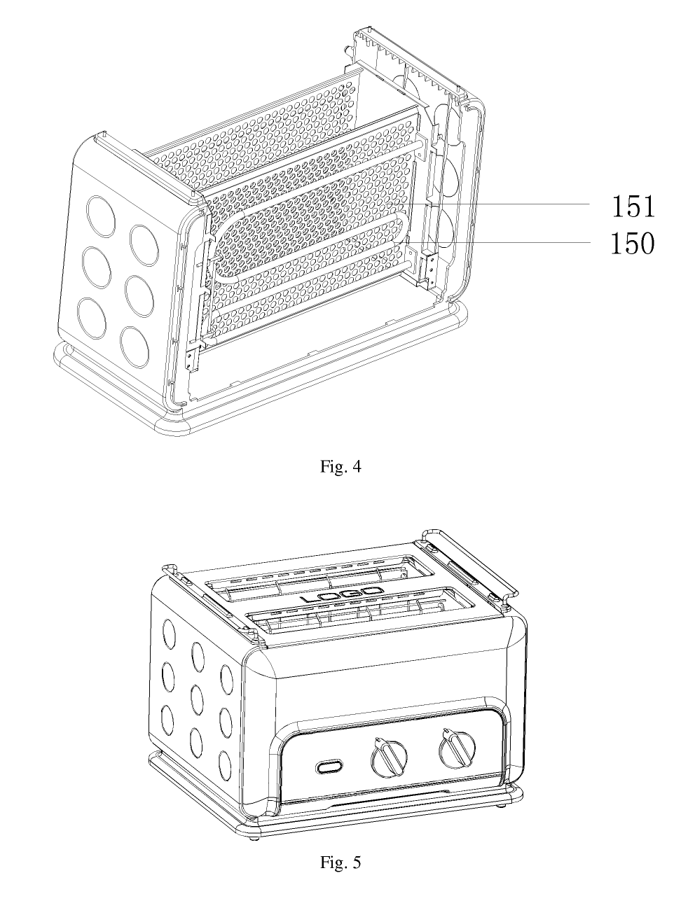

Refer to FIG. 3 then. FIG. 3 is a schematic representation of the preferred embodiment of the internally electric heated barbecue's structure decomposition in the present invention. As shown in the figure, the cabinet 100 of the internally electric heated barbecue provided in the present invention has vertical heating units 150 symmetrically disposed at both sides inside it, one on the front side, the other on the back side, which may be tubular electric heating element or infrared heating tube, wherein the distance between the vertical heating units 150 can be 90 mm-200 mm One embodiment of the structure of the electric heating unit 150 is shown in FIG. 4. The electric heating unit 150 comprises a plurality of heating tubes, which are connected in a parallel arrangement, forming an “S” shaped structure. The intervals between adjacent heating tubes decrease from top down. By using such asymmetrical structure of the electric heating unit 150, more heat is provided at the bottom of the cabinet 100 to compensate the heat loss caused by the rise of the heat from the bottom up, so that the temperature inside the cabinet 100 is relatively even and stable, thus avoiding flipping food and some trouble in operating. Meanwhile, the electric heating units 150 are respectively equipped with food separating grid 151 to prevent the barbecue rack 200 from touching the electric heating unit 150 while being placed into the cabinet 100. Inside the cabinet 100 is a timer 121 and a temperature controller 131 which are separately connected to the timing unit 120 and temperature control unit 130 so as to control the barbecuing time and temperature; the cabinet 100 is also equipped with a temperature protector (not shown in the figure) and laminated micas 161 and 162. Insulating boards are separately equipped on the sides of the cabinet 100 and on the ground to maintain the barbecuing temperature inside the cabinet 100 so as to avoid energy loss and to reduce energy consumption, as well as to avoid damaging user by the superheated housing of the internally electric heated barbecue.

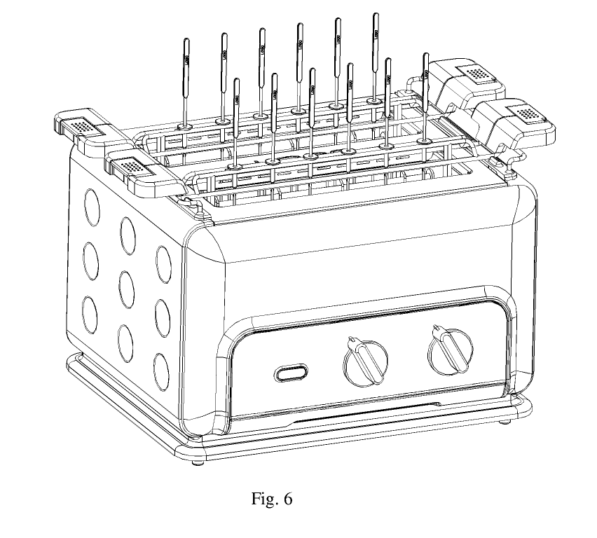

Refer to FIG. 5-FIG. 7 then. FIG. 5-FIG. 7 are schematic representations of another preferred embodiment of the internally electric heated barbecue's structure in the present invention. The internally electric heated barbecue as shown in FIG. 5-FIG. 7 has 2 top openings so as to barbecue more food simultaneously in the 2 different openings. Two barbecue racks are mounted on top of the cabinet. Three electric heating units are symmetrically disposed inside the cabinet, one on the front side, one on the back side, and the other in the centre. It should be mentioned that, the number of top opening can be tailored in accordance with the user requirement. In an n-opening structure, n barbecue racks and n+1 electric heating units are adopted, wherein each opening has a width of 55 mm-100 mm.

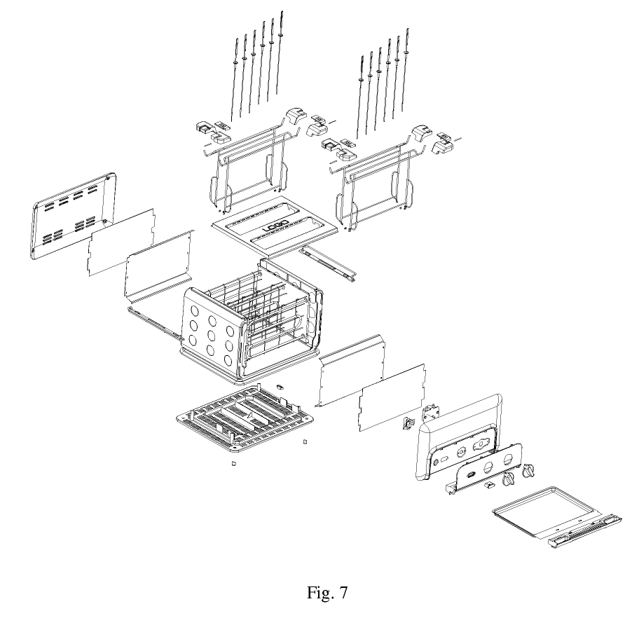

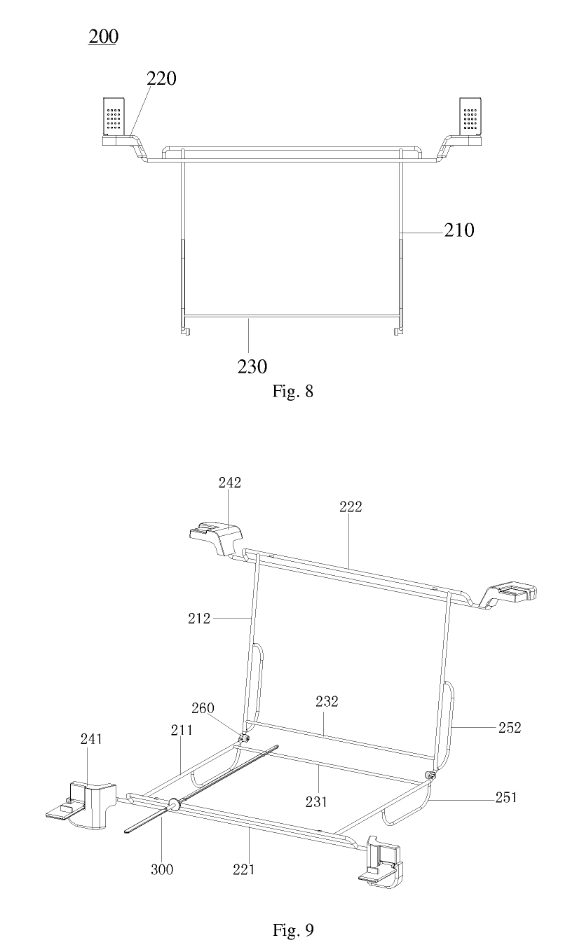

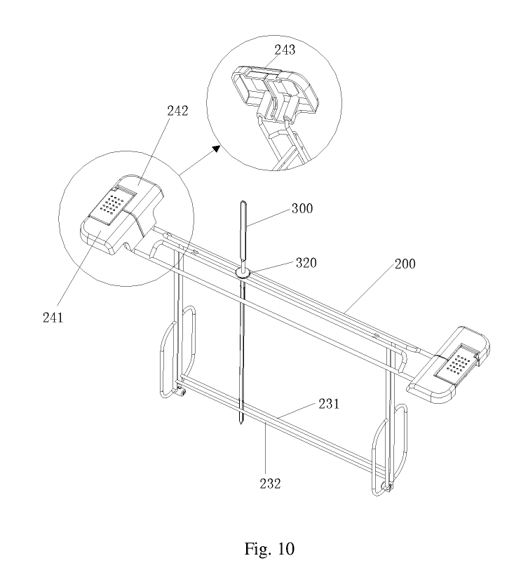

Refer to FIG. 8 and FIG. 9 then. FIG. 8 is a schematic representation of the preferred embodiment of the barbecue rack's closing status in the present invention, and FIG. 9 is a schematic representation of the preferred embodiment of the barbecue rack's opening status in the present invention. The barbecue rack 200 comprises a barbecue frame 210 and a support rod holder 220, wherein the barbecue frame 210 is set within the opening of the cabinet 100 during barbecuing, while the support rod holder 220 is set on the rack supporting part 140 during barbecuing. The support rod holder 220 of the barbecue rack 200 has convexity which are set in the concavity 141 of the aforesaid rack supporting part 140 to limit the position of the barbecue rack 200, and the support rod holder 220 of the barbecue rack 200 is supported on the supporting part 142 on the aforesaid rack supporting part 140 to prevent the barbecue rack 200 from falling into the cabinet 100. The barbecue frame 210 of the barbecue rack 200 consists of a first frame 211 and a second frame 212, and the two frames 211 and 212 are pin joined at one end of them by rotating shafts 260; the support rod holder 220 of the barbecue rack 200 consists of a first rod holder 221 and a second rod holder 222, and the two rod holders 221 and 222 are fixed separately and connected to the other sides of the two frames 211 and 212, wherein the surfaces of the rod holders 221 and 222 are inclined planes to give space for avoiding hand touching while using. Blocking racks 230 are mounted on the two frames 211 and 212 near the pin joining parts to form an anti-food-falling blocking area to prevent the food on the food skewers 300 from falling to the bottom of the cabinet 100 due to the gravity during barbecuing, and meanwhile ensure the cleanness inside the barbecue cabinet 100. The blocking rack 230 consists of two stop pins 231 and 232. As shown in FIG. 10, when the barbecue rack is in a closing status, a certain distance is left between the two stop pins 231 and 232, which enables the end of the food skewer 300 to pass through while preventing the food to go through, thereby keeping the food within the effective heating area when barbecuing. The gap between the stop pins 231 and 232 also facilitates the positioning of the food skewers 300 into the barbecue rack 200. In addition, the two frames 211 and 212 are respectively equipped with arc withstanding frames 251 and 252 at the outer sides, which facilitate taking and placing food. When the barbecue rack 200 is installed in the cabinet 100, the food is kept between the inner sides of the frames 211 and 212, so that the arc withstanding frames 251 and 252 can avoid the food from touching the internal of the cabinet 100 and keep the cabinet 100 clean; moreover, the arc withstanding frames 251 and 252 can make the food on the food skewer hang in the air while opening the barbecue rack, thus effectively preventing food from touching the surface below. The two rod holders 221 and 222 have buckling parts 241 and 242 cooperating with each other, which ensure the food skewers 300 are fixed firmly on the barbecue rack 200 while combining the two frames 211 and 212.

Refer to FIG. 10 then. FIG. 10 is a schematic representation of the preferred embodiment of the barbecue rack's utilizing status in the present invention. The food skewer 300 is firmly clamped by the barbecue rack 200. The food skewer 300 consists of a support locating part 320 for supporting and locating the food skewer 300 on the barbecue rack 200, while the blocking rack 230 serves as the anti-food-falling blocking area. Wherein the buckling parts 241 and 242 of the two rod holders 221 and 222 leave a certain space 243 while being buckled together so as to move aside the closed cover above easily with finger(s).

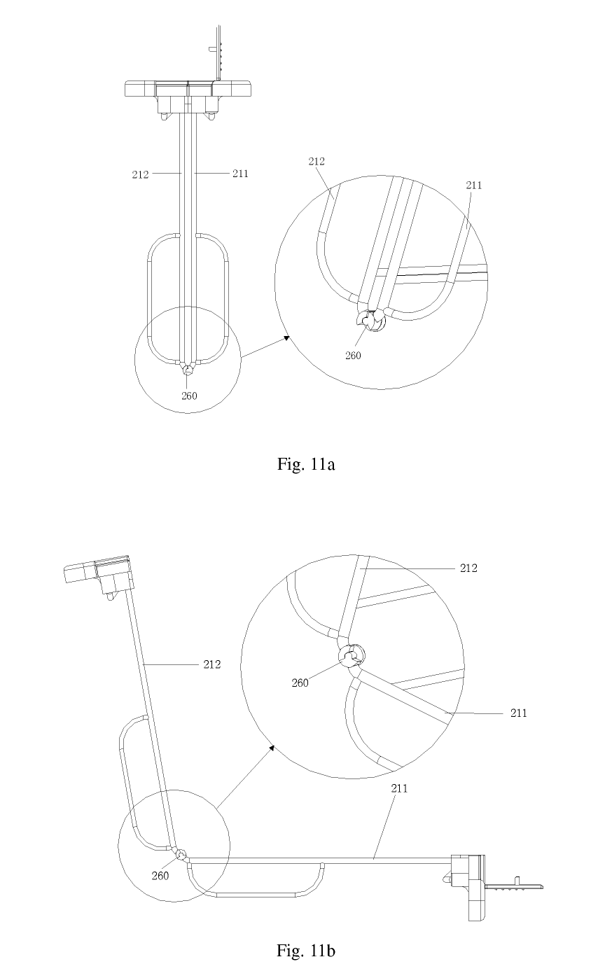

Refer to FIGS. 11a and 11b then. FIG. 11a and FIG. 11b are schematic representations of the barbecue frames respectively in a closing and an opening status. Rotating shafts 260 are used to limit the open angle of the two frames 211 and 212. In this embodiment, the open angle of the two frames 211 and 212 is limited to be in the range of 0°-110°. In other embodiments, the maximum value of the open angle could be 100°-115°. If a larger open angle is adopted, the frames 211 and 212 in an opening status will occupy a large operating space, and are easy to touch other objects. It is also difficult for the user to reach the support rod holder 220 while he wants to close the frames 211 and 212 from the front side. By limiting the open angle within an appropriate range, one can effectively avoid burning other objects due to the large open angle of the frames under continuous use of the barbecue, and reducing the operating space at the same time.

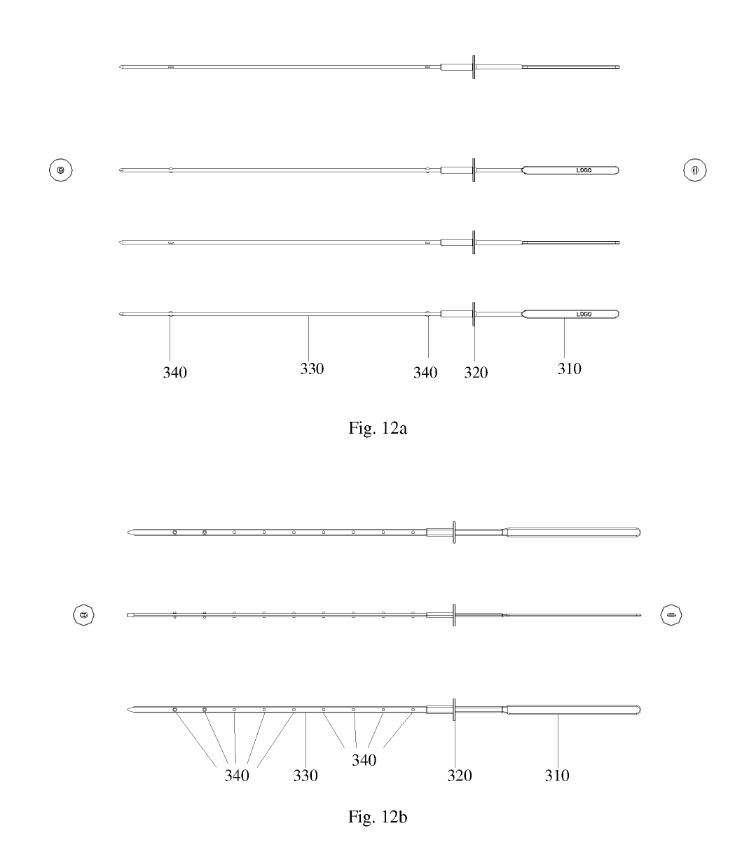

Refer to FIGS. 12a, 12b and 12c then. FIG. 12a, FIG. 12b and FIG. 12c are schematic representations of the preferred embodiment of the food skewer's structure. As shown in the figures, the food skewer 300 consists of a handle 310, a support locating part 320 and a food fixing part 330. While the support locating part 320 is a locating disc or a locating part of other shapes, and the food fixing part 330 is cylindrical or flat (see the left-sided and right-sided views of the food skewer in each figure), suitable for different food; while barbecuing, the food fixing part 330 is clamped by the barbecue rack 200, and the support locating part 320 limits the handle 310 to outside the barbecue rack 200 for easy taking out; wherein the food fixing part 330 as shown in FIG. 12a and FIG. 12b contains two limiting convexities 340 for limiting the food between the two limiting convexities 340; the food fixing part 330 as shown in FIG. 12c contains lots of limiting convexities 340 for limiting the food and easy cleaning as well as preventing food from falling down.

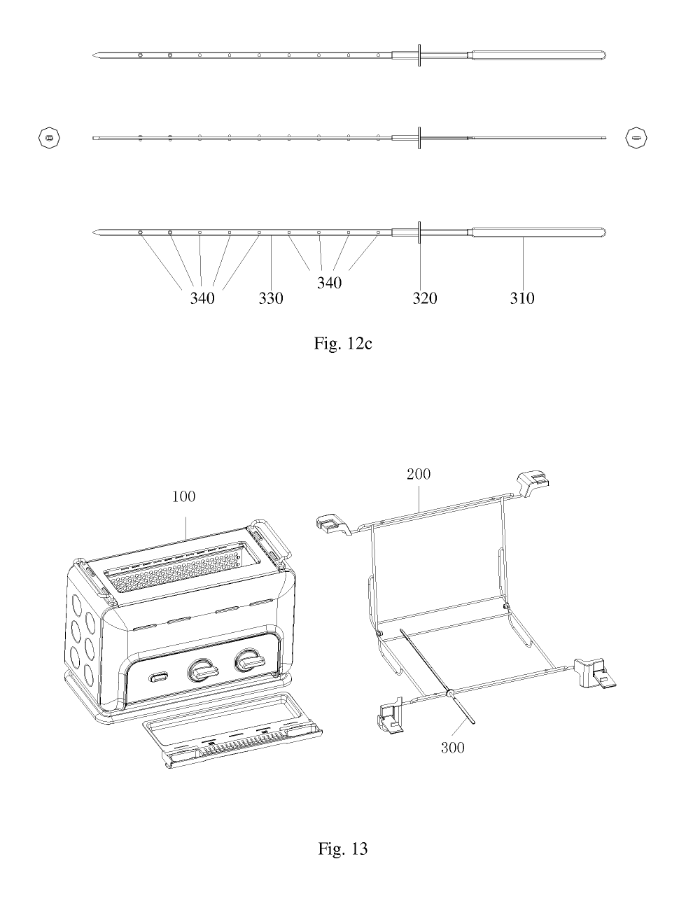

Refer to FIG. 13 then. FIG. 13 is a schematic representation of the preferred embodiment of the internally electric heated barbecue's overall structure in the present invention. The internally electric heated barbecue provided in the present invention consists of a cabinet 100, a barbecue rack 200 and food skewers 300. The opening of the cabinet has an appropriate width, which eliminates the sanitary problems caused by the contact of the food with other parts due to smaller opening during placing the barbecue rack into the barbecue and the burnt smell problems during barbecuing, and also eliminates the energy-consuming problem caused by rapid heat loss due to big opening and the uneven food heating problems; the combination of two-sided vertical heating unit and the barbecue rack provides relatively even and stable temperature inside the barbecue, eliminating the need for flipping food, instead, makes barbecuing easy and controllable by controlling the time and temperature. Furthermore, by using this energy-saving design, the power of the barbecue is effectively reduced to 1100-1200 W, compared with 1800 W of traditional barbecues, while the time for cooking is the same with traditional barbecues. The present invention has the advantages of being energy-saving, easy to clean and convenient to operate, capable of removing excessive grease effectively and controlling barbecuing quality.

Although the present invention has been disclosed with reference to the preferred embodiments, it is not to limit the present invention. Those with common knowledge in the technical field of the present invention may modify and render it without departing from the spirit and scope of the invention. Therefore, the protection scope of the present invention shall be governed by that defined in the Claims.

What is claimed is:

1. An internally electric heated barbecue, comprising a cabinet and a barbecue rack, wherein, the cabinet has a rack supporting part and at least one opening at its top, each opening having a width of 55 mm-100 mm; the cabinet further comprises electric heating units disposed at both sides inside it; the barbecue rack comprises a barbecue frame and a support rod holder, the barbecue frame being disposed within the opening, the support rod holder being supported by the rack supporting part, and the barbecue rack is further equipped with food skewers.

2. The internally electric heated barbecue according to claim 1, wherein the electric heating unit has an asymmetrical structure to provide more heat to the bottom of the cabinet.

3. The internally electric heated barbecue according to claim 2, wherein the electric heating unit comprises a plurality of parallel arranged heating tubes, and the intervals between adjacent heating tubes decrease from top down.

4. The internally electric heated barbecue according to claim 1, wherein the rack supporting part has a concavity and a supporting part, the barbecue rack's support rod holder has a convexity matching with the concavity to limit the position of the barbecue rack, and the supporting part is used to support the barbecue rack's support rod holder.

5. The internally electric heated barbecue according to claim 1, wherein the barbecue rack's barbecue frame consists of a first frame and a second frame, which are pin joined at one end; the barbecue rack's support rod holder consists of a first rod holder and a second rod holder, which are fixed separately and connected to the other sides of the two frames.

6. The internally electric heated barbecue according to claim 5, wherein blocking racks are mounted on the two frames near the pin joining part to avoid food from falling to the bottom of the cabinet when barbecuing.

7. The internally electric heated barbecue according to claim 5, wherein the two frames have arc withstanding frames respectively mounted at the outer sides.

8. The internally electric heated barbecue according to claim 5, wherein the first frame and the second frame are pin joined by rotating shafts, wherein, the rotating shafts can limit the open angle of the frames.

9. The internally electric heated barbecue according to claim 5, wherein the two rod holders have buckling parts which cooperate with each other.

10. The internally electric heated barbecue according to claim 1, wherein the food skewer comprises a handle, a support locating part and a food fixing part; the food fixing part is cylindrical or flat, and the food fixing part contains two or more limiting convexities.

11. The internally electric heated barbecue according to claim 10, wherein the support locating part is a locating disc and the food fixing part is clamped by the barbecue rack, the support locating part limiting the handle to outside of the barbecue rack.

12. The internally electric heated barbecue according to claim 1, wherein the cabinet has a removable water tank at the bottom.

13. The internally electric heated barbecue according to claim 1, wherein the internally electric heated barbecue has a temperature control unit and a timing unit.
